(19) United States
(12) Patent Application Publication
(10) Pub. No.: US 2011/0005211 A1
(43) Pub. Date: Jan. 13, 2011

(54) COATING OF SUBSTRATES ENSURING A HIGH POROSITY WITH SIMUTANEOUSLY HIGH ABRASION RESISTANCE OF THE COATING

(75) Inventors: Arno Tissler, Tegernheim (DE); Volker Kurth, Bad Aibling (DE)

Correspondence Address: CONNOLLY BOVE LODGE & HUTZ LLP, 1875 EYE STREET, N.W., SUITE 1100, WASHINGTON, DC, 20006, US

(73) Assignee: SUD-CHEMIE AG, Munich (DE)

(21) Appl. No.: 12/682,047

(22) PCT Filed: Oct. 7, 2008
(86) PCT No.: PCT/EP08/08449

§ 371 Date: Sep. 10, 2010

(30) Foreign Application Priority Data
Oct. 9, 2007 (DE) 10 2007 048 313.0

(51) Int. Cl. F01N 3/035; B01J 31/06; B01J 29/068

(52) U.S. Cl. 60/297; 502/62; 502/159

(57) ABSTRACT

The invention relates to a coating suspension for the coating of catalyst substrates which comprises a polymeric pore-forming agent. The invention also relates to methods for coating catalyst substrates, by a) preparing a coating suspension and a catalyst substrate b) applying the coating suspension to the catalyst substrate, c) drying and calcining the applied coating, wherein the coating suspension contains a polymeric pore-forming agent which is removed residue-free in step c). Furthermore the invention relates to a catalyst which comprises the coated catalyst substrate according to the invention.

The present invention relates to coating suspensions for coating catalyst substrates, a method for coating catalyst substrates and a catalyst which comprises the catalyst substrates coated according to the invention.

In recent years, the statutory exhaust-gas standards for combustion-engine vehicles have become steadily stricter. Measures inside engines are no longer sufficient to satisfy legal requirements. Therefore, modern vehicle catalysts are necessary for exhaust-gas after-treatment in order to meet exhaust-gas limit values.

The task of vehicle catalysts is the chemical conversion of the combustion pollutants hydrocarbons, carbon monoxide (CO) and nitrous oxides (NOₓ) to carbon dioxide (CO₂), water (H₂O) and nitrogen (N₂) by oxidation or reduction. Depending on the task, there are different types of catalyst. In a three-way catalyst, the oxidation of CO and hydrocarbons as well as the reduction of NOₓ take place in parallel. The three-way catalyst can be used only in vehicles with an Otto engine and Lambda control. In a diesel engine, the surplus of oxygen in the exhaust gas prevents the reduction of the NOₓ and therefore necessitates special catalysts.

In order to reduce the level of NOₓ in the exhaust gas, on the one hand measures can be taken inside the engine, through which the combustion is influenced in targeted manner. A disadvantage with these measures is, however, an increased soot emission and a reduction in engine performance. Because of clearly lower exhaust-gas temperatures compared with an Otto engine, catalysts in diesel engines are often installed near to the exhaust manifold. The aim of the catalysts in diesel engines is not only NOₓ minimization but also the oxidation of the soot particles and unburned hydrocarbons in order to reduce the emission of fines. Catalysts of this type are the well-known diesel oxidation catalysts. These catalysts are usually equipped with a catalytically active coating which contains platinum and/or palladium.

A further type of catalyst is the NOₓ trap catalyst. As modern engines operate with an oxygen surplus to increase engine efficiency, conventional catalysts cannot be used. The oxidation of CO and hydrocarbons takes place analogously to the conventional three-way catalyst, but nitrous oxides must be temporarily stored. Their catalytic reduction is intermittent with a rich exhaust-gas mixture. If the capacity of the catalyst is completely occupied by nitrous oxides, a rich, i.e. reducing exhaust-gas mixture is briefly set with the result that the nitrous oxides temporarily stored in the catalyst are reduced to nitrogen. The catalyst is thus prepared for the next storage cycle.

A further method now ready for the market for reducing nitrous oxides is the so-called selective catalytic reduction (SCR). An aqueous urea solution is continuously injected into the exhaust-gas stream, e.g. by means of a dosing pump. Water and ammonia thus result through hydrolysis, wherein the ammonia can reduce the nitrous oxides in the exhaust gas to nitrogen.

The vehicle catalyst consists of several components. A temperature-stable honeycomb body made of a ceramic or a metal, as a rule so-called monoliths or of the metal support metallite through which a plurality of thin-walled channels pass, serves as catalyst substrate. Foam structures made of ceramic or metal also serve as catalyst substrate.

A catalytically active coating is applied to the catalyst substrate. This coating is a porous oxide layer through which the catalyst obtains a larger surface area and a specific structure. In this catalyst coating, the catalytically active noble metals which accelerate the desired reaction are embedded. In modern exhaust-gas catalysts these are often the noble metals platinum, rhodium and palladium.

To produce the coated catalyst substrate this is brought into contact with a coating suspension which is known as a washcoat to a person skilled in the art. This contains inorganic carrier materials which have a large surface area, in most cases a BET surface area of more than 8 m²/g. The catalytically active noble metals are applied to the surface of the inorganic carrier materials. Known coating suspensions contain as inorganic carrier materials for example aluminium oxide (Al₂O₃) or titanium dioxide (TiO₂). In addition to the carrier materials, coating suspensions typically contain further metal oxides as promoters or oxygen traps which can likewise be coated with metals of the platinum group as well as inert, thermally stable filling material. Zirconium oxide for example is used as promoter.

The accessibility of gases to be converted to the catalytically active centres is improved by increasing the porosity. Therefore, an aim is to increase the porosity of the coated catalyst substrate.

A high abrasion resistance is also necessary. As little coating material as possible is to be worn away while the catalyst is operating. In practice it has been shown that the two properties high porosity and abrasion resistance behave in opposite ways to each other. A coating with a high porosity shows a smaller abrasion resistance. Therefore, in practice, a compromise is reached between the two values.

In order to achieve an increase in the porosity of the coating, organic burnout materials such as for example cellulose or polyvinyl alcohol are contained in the coating suspension. During the calcination of the coated catalyst substrate these burnout materials are removed from the coating and leave behind pores, whereby, although the surface area is increased, the abrasion resistance is reduced.

A method for forming powders into shaped bodies which have a large pore volume is disclosed in DE-A-10 2005 052 016. With this process a catalytically active powder consisting of particles with defined internal porosity is mixed with an inelastic pore-forming agent, then shaped and calcined. The inelastic pore-forming agent is removed by the calcination and a porous shaped body results. Organic additives often have the disadvantage that they do not always burn off residue-free, in particular when using amorphous carbon, with the result that the calcination is often followed by an expensive after-treatment step in order to remove the residues of the organic additives after calcination.

Thus the object of the invention was to provide a coating suspension and a method by which a coated catalyst substrate is obtained which has a high porosity and a high abrasion resistance. The object of the invention was further to provide a catalyst which comprises a catalyst substrate with coating, wherein the coating has a high porosity and a high abrasion resistance. A further object was to avoid an after-treatment of the catalysts obtained through the process according to the invention.

The object is achieved by a coating suspension for coating catalyst substrates which contains a) an inorganic carrier material and b) a polymeric pore-forming agent, wherein the polymeric pore-forming agent is composed of agglomerated polymeric primary particles.

The polymeric pore-forming agent, which is contained in the coating suspension applied to the catalyst substrate, burns residue-free during the calcination. Pores or free spaces are left behind with the result that the surface area of the coating is greater than the surface area of coatings which do not contain pore-forming agent. As already mentioned above, the use of polymeric pore-forming agents is known from DE 10 2005 052 016. There, shaped bodies are produced which contain polymeric pore-forming agents.

Surprisingly it was found, however, that polymeric pore-forming agents can also be contained in coating suspensions and the thus-produced coatings continue to adhere to the catalyst substrate after the burning-off of the pore-forming agents and do not delaminate. The expectation that the pores mechanically destabilize the coating so that the coatings delaminate was not confirmed.

Compared with the solid catalysts of DE 10 2005 052 016 the coating suspension according to the invention has the advantage that the polymeric pore-forming agent can be mixed into the coating suspension without the primary particles suffering damage, as the coating suspensions have a lower viscosity, compared with extruded masses of complete catalysts, with the result that the primary particles are not subjected to excessive mechanical load.

The polymeric pore-forming agent preferably comprises a polymer or copolymer selected from the group consisting of polyethylene, polypropylene, polyurethanes, polyacrylnitriles, polyacrylate, polyvinylacetate, polystyrene and mixtures thereof. According to the invention any copolymers of the above-named polymers can be used. For example, polypropylene-polyethylene copolymers are used for the coating suspension. Furthermore, mixtures, i.e. blends of the above-named polymers can also be used. The named polymers are low-cost representatives of emulsion polymerizates. Furthermore, the above-named polymers or their copolymers burn residue-free.

The polymeric pore-forming agent preferably also comprises an artificial resin. This artificial resin is e.g. a polystyrene resin, polypropylene resin, or polypropylene-polyethylene resin. Artificial resins are understood to mean, within the framework of this invention, synthetic resins according to DIN 55958 (December 1988) which are produced by polymerization, polyaddition or polycondensation reactions. They can be modified by naturally occurring substances, for example vegetable or animal oils or natural resins or produced by esterification or saponification of natural resins. The artificial resins are largely amorphous polymeric products without a clearly defined softening or melting point.

The polymeric pore-forming agent is usually composed of agglomerated polymeric primary particles which can preferably be globular or spherical. Other geometric shapes can also likewise be used within the framework of the invention, but these are harder to produce in process-engineering terms. Polymeric pore-forming agents are preferably used which have primary particles with an average diameter of from 0.5 to 2 μm, particularly preferably of from 0.7 to 1.5 μm, quite particularly preferably an average diameter of approximately 1 μm.

In a particularly preferred further embodiment the primary particles form substantially spherical agglomerates. The agglomerated polymeric primary particles have an arithmetic mean diameter of from 10 to 100 μm. The globular or spherical primary particles form substructures in this agglomerate, which are regular to a greater or lesser degree. The term “spherically” is here meant topologically, covering bodies which can be defined by means of spherical coordinates in space, thus e.g. also cubic objects, distorted spheres, ovoid bodies etc. The agglomerated polymeric primary particles can be disagglomerated, in particular under the influence of ultrasound.

The polymeric pore-forming agent is particularly preferably, relative to the solids content of the suspension, contained in the coating suspension in a quantity of from 0.5 to 8 wt.-%, more preferably in a quantity of from 0.5 to 4 wt.-31 % and most preferably in a quantity of from 2 wt.-%. Larger quantities reduce the friction resistance, smaller quantities bring about too small a porosity.

Catalytically active material which accelerates the desired conversion in the catalyst is found on the surface of the inorganic carrier material. Metal or semi-metal oxides serve as preferred inorganic carrier materials. The inorganic carrier material is preferably selected from the group consisting of aluminium oxide, silicon dioxide, silicon-aluminium dioxide, zirconium dioxide, titanium dioxide, cerium oxide, cerium-zirconium oxide and a zeolite. Aluminium oxide, cerium-zirconium oxide or cerium oxide are quite particularly preferred. The preferred inorganic carrier materials are temperature-resistant and are particularly low in cost among temperature-resistant materials.

In a preferred embodiment the coating suspension also contains a promoter. This is added to a catalyst in order to enhance the effect of the actual catalyst. Thus the composition according to the invention can contain an inorganic carrier material, a polymeric pore-forming agent and a promoter. In preferred developments of the invention the promoter acts simultaneously as an oxygen trap. A person skilled in the art knows that not every promoter is simultaneously also an oxygen trap.

By an oxygen trap is meant within the framework of this invention a substance in which monoatomic oxygen can be transported and by which oxygen can be taken up and from which oxygen can be released. Other promoters improve the dispersion or reduction of noble metals.

In a particularly preferred embodiment the promoter comprises tin oxide or a lanthanide oxide, in particular a cerium oxide or praseodymium oxide Pr₆O₁₁ or neodymium oxide Nd₂O₃. These simultaneously act as oxygen traps. According to the invention the promoters can be added to the coating suspension in order to enhance the effect of the catalytically active noble metals.

In a preferred embodiment the coating suspension also contains a stabilizer. Thus the composition according to the invention can contain an inorganic carrier material, a polymeric pore-forming agent and a stabilizer as well as optionally a promoter.

A person skilled in the art understands by a stabilizer a substance which reduces the extent of phase transitions at high temperatures. For example at high temperatures the structure of the surface of aluminium oxide is changed (see “Catalysis from A to Z”, published by B. Cornils, W. A. Herrmann, M. Muhler, C.-H. Wong, Wiley-VCH, 2007, Volume III, page 1323). The change involves a loss in specific surface area. Stabilizers are added in order to reduce this loss of specific surface area. Preferred stabilizers are selected from the group consisting of tungsten oxide, lanthanum oxide, zirconium dioxide, silicon dioxide, yttrium oxide, cerium oxide, iron oxide or tin oxide, wherein the stabilizers can be present homogenously mixed with the carrier material. The carrier materials can be stabilized to different extents by the stabilizers. Not every stabilizer stabilizes every carrier material equally effectively. Aluminium oxide is particularly well stabilized by lanthanum oxide; cerium oxide, as inorganic carrier material, is particularly well stabilized by zirconium oxide.

A particularly preferred coating suspension also contains e) a trapping material. Thus the coating suspension according to the invention can contain an inorganic carrier material, a polymeric pore-forming agent and a trapping material as well as optionally a stabilizer or a promoter, wherein the latter can also be an oxygen trap. This differs fundamentally from the trap material which can be added in order for example to be able to trap unburned hydrocarbons. Trapping materials are for example zeolites or alkaline-earth metal oxides.

Zeolites are particularly preferred preferably used as trapping materials for unburned hydrocarbons. For this purpose the zeolite is preferably present in the H form or is a metal(-ion)-exchanged zeolite. The trapping of unburned hydrocarbons is important in the phase after starting the engine. A person skilled in the art knows which type of zeolite can be used as trap material and which type of zeolite can be used as inorganic carrier material.

An alkaline-earth metal oxide such as CaOBaO or SrO is particularly preferably used as trap material for trapping NOₓ.

The coating suspension can preferably also contain f) metals of the sub-group VIII or I. The metals are particularly preferably selected from the group consisting of palladium, platinum, rhodium, silver, gold, iridium and ruthenium. The metals are the catalytically active components which accelerate the desired reaction in the catalyst. Alternatively, the metals can be applied after the coating of the catalyst substrate.

In a preferred embodiment of the invention the coating suspension also contains g) a filler. This is particularly preferably selected from the group consisting of cordierite, mullite, magnesium-aluminium titanate and mixtures thereof. A cost advantage is achieved by using fillers. The fillers are inert and do not negatively influence the function of further components.

The object forming the basis of the inventions is also achieved by a method for coating catalyst substrates, in which
a) a coating suspension and a catalyst substrate are provided,
b) the coating suspension is applied to the catalyst substrate with the result that a coating results,
c) the coating is dried and calcined,
   wherein the coating suspension contains a polymeric pore-forming agent which is removed residue-free in step c).

By “residue-free” is meant within the framework of this invention that after removing the pore-forming agent less than 200 wt.-ppm residue from the pore-forming agent remains in the coating.

The polymeric pore-forming agent contained in the coating suspension according to the invention is burned out by the calcination. A coated catalyst substrate is thereby obtained which has a greater proportion of pores of the order of magnitude of 1 μm. The surface area of the coating is increased and it was surprisingly found that the coating is particularly abrasion-resistant. All of the above-named materials are used as polymeric pore-forming agents (see the above description of the coating suspension according to the invention).

Surprisingly it was also found that with the process according to the invention expensive after-treatment steps of the catalyst substrate obtained with the coating suspension according to the invention can be avoided. This also results in the catalyst substrate coated with the coating suspension according to the invention coking less during use in a catalytic process than do conventional coated catalyst substrates which are obtained by using organic pore-forming agents, with the result that the life in the catalytic cycles is longer compared with coatings which are produced from conventional coating suspensions.

In a further preferred process for coating a catalyst substrate, the coating suspension contains the polymeric pore-forming agent which is disagglomerated by an ultrasound treatment. This ultrasound treatment is carried out before or after the addition of the polymeric pore-forming agent to the coating suspension. The primary particles can be to isolated by this processing step. The isolation of the primary particles is also achieved partly by mixing in the polymeric pore-forming agent. The isolation takes place to a greater extent due to the ultrasound treatment.

In a preferred process for coating catalyst substrates the calcination in step c) takes place at a temperature of between 450° C. and 600° C., particularly preferably of between 500° C. and 600° C. From below 400 to approx. 450° C. the polymeric material and the additives are generally not burned out or transformed, above approx. 600° C. there is the danger of the catalyst being damaged by the thermal stress. Thus the catalysis capacity of the coated catalyst substrate falls. However, it is found that a temperature of more than 600° C. is also definitely briefly possible in order to completely burn out any last residues. However, temperatures in the temperature range of between 600 to 700° C. should not be allowed to act on the catalyst substrate according to the invention for too long in order to rule out thermally induced damaged and thus a poorer catalytic activity from the outset.

The object forming the basis of the invention is also achieved by a catalyst with a coating wherein the catalyst has a coating produced according to the invention. The catalytically active coating has a greater porosity in the pore-diameter range of from 0.5 μm to 2 μm, preferably of from 0.7 to 1.5 μm and most preferably of from approximately 1 μm.

The catalyst according to the invention is used as diesel particle filter, diesel oxidation catalyst, NOₓ trap catalyst or for selective catalytic reduction.

The invention is described in more detail below using an embodiment example with the latter not to be understood as limiting:

### Embodiment Example

1. Increasing the porosity of a coating according to the state of the art:

For this purpose metal sheets measuring 25×90 mm were coated with a washcoat. The washcoat was composed as follows: 200 g lanthanum-stabilized aluminium oxide (Sasol Puralox SCFa 140L), 250 g water, 3.5 g acetic acid, 1.56 g colloidal alumina (A1 20 from Nyacol). 1% polyvinyl alcohol was also added to the composition, relative to the solids content. After drying at 120° C. the coated sheets were calcined at 550° C. for 3 hours. The organic additive was thereby burned out accompanied by the formation of additional pores. The coated sheets (coating mass: 80 mg) were then subjected to an abrasion test using compressed air. The 25-mm wide coated sheet was clamped into a holder for the test. The compressed air nozzle has an internal diameter of 4 mm and was arranged at a distance of 9 mm in front of the sheet. The admission pressure at the manometer was set to 6 bar. The sharp compressed-air stream was directed towards the coating for 15 s. It was shown that the coating was worn away from 75% of the original coating.

A second metal sheet was correspondingly coated with a washcoat, wherein the addition of polyvinyl alcohol was dispensed with, then dried and calcined. The friction test on the coated sheets (coating mass: 70 mg) led to a detachment of the washcoat over 50% of the coated surface. The coating has pores mainly in the pore-diameter range between 7.5 and 40 nm. The pore diameter was determined by means of mercury porosimetry according to DIN 66133 at a maximum pressure of 2000 bar.

A comparison of coated sheets with and without pore-forming agents shows that the friction resistance is significantly reduced by the addition of organic additives.

2. Increasing the porosity of a coating according to the invention:

Metal sheets measuring 25×90 mm were coated with a washcoat with the same composition as in example 1. However, instead of the polyvinyl alcohol, 2% polymer resin (Almatex Muticle PP600) relative to the solids content was added to this composition as pore-forming agent. This is a polymeric pore-forming agent which is composed of spheres which have a diameter of approximately 1 μm (arithmetic mean). By applying ultrasound disagglomeration took place before the coating of the polymeric pore-forming agents. After the coating and drying at 120° C. the coated sheets were calcined at 550° C., wherein the organic additive is burned out accompanied by the formation of the pores. The coated sheets (coating mass: 50 mg) were then subjected to the above-described friction test with compressed air. It was shown that the coating was worn away over 50% of the coated surface. In addition to pores with pore diameters of from between 7.5 and 40 nm the coating also has pores with pore diameters of approximately 1 μm. The pore diameters were determined by means of mercury porosimetry according to DIN 66133 at a maximum pressure of 2000 bar.

The abrasion resistance of the coating did not decrease because of the addition of the pore-forming agent Almatex Muticle. Both when coating without pore-forming agent and when coating according to the invention, i.e. with 2% organic additive, only 50% of the coated surface was worn away by the abrasion test. On the other hand, 75% of the coated surface was worn away when coating with a pore-forming agent according to the state of the art.

1. Coating suspension for coating catalyst substrates which contains
a) an inorganic carrier material and
b) a polymeric pore-forming agent
characterized in that the polymeric pore-forming agent is composed of agglomerated polymeric primary particles.

2. Coating suspension according to claim 1, wherein the polymeric pore-forming agent comprises a polymer or copolymer selected from the group consisting of polyethylene, polypropylene, polyurethanes, polyacrylnitriles, polyacrylate, polymethacrylate, polyvinylacetate, polystyrene and mixtures thereof.

3. Coating suspension according to one of the previous claims, characterized in that claim 1, wherein the polymeric pore-forming agent comprises an artificial resin.

4. Coating suspension according to claim 1, wherein the primary particles have an arithmetic mean diameter of from 0.5 μm to 2 μm.

5. Coating suspension according to claim 1, wherein the agglomerated polymeric primary particles have an arithmetic mean diameter of from 10 μm to 100 μm.

6. Coating suspension according to claim 1, wherein the agglomerated polymeric primary particles can be disagglomerated.

7. Coating suspension according to claim 1, wherein the polymeric pore-forming agent, relative to the solids content of the coating suspension, is contained in a quantity of from 0.5 to 8 wt.-% in the coating suspension.

8. Coating suspension according to claim 1, wherein the inorganic carrier material is a metal or semi-metal oxide selected from the group consisting of aluminium oxide, silicon dioxide, silicon-aluminium oxide, zirconium dioxide, titanium dioxide, cerium oxide, cerium-zirconium oxide and a zeolite.

9. Coating suspension according to claim 8, wherein the inorganic carrier material is in particular aluminium oxide, cerium-zirconium oxide or cerium oxide.

10. Coating suspension according to claim 1, wherein the coating suspension also contains
c) a promoter.

11. Coating suspension according to claim 10, wherein the promoter comprises tin oxide or a lanthanide oxide.

12. Coating suspension according to claim 1, wherein the coating suspension also contains
d) a stabilizer.

13. Coating suspension according to claim 12, wherein the stabilizer is selected from the group consisting of tungsten oxide, lanthanum oxide, zirconium dioxide, silicon dioxide, yttrium oxide, cerium oxide, iron oxide and tin oxide.

14. Coating suspension according to claim 1, wherein the coating suspension also contains
e) a trapping material.

15. Coating suspension according to claim 14, wherein the trapping material is a zeolite.

16. Coating suspension according to claim 14, wherein the trapping material is an alkaline-earth metal oxide.

17. Coating suspension according to claim 1, wherein the coating suspension also contains
f) metals of the sub-group VIII or I.

18. Coating suspension according to claim 17, wherein the metals are selected from the group consisting of palladium, platinum, rhodium, silver, gold, iridium and ruthenium.

19. Coating suspension according to claim 1, wherein the coating suspension also contains
g) a filler.

20. Coating suspension according to claim 19, wherein the filler is selected from the group consisting of cordierite, mullite, magnesium aluminium titanate and mixtures thereof.

21. Process for the coating of a catalyst substrate, in which
a) a coating suspension and a catalyst substrate are provided,
b) the coating suspension is applied to the catalyst substrate,
c) the applied coating is dried and calcined,
wherein the coating suspension contains a polymeric pore-forming agent which is removed free from residue in step c).

22. Process for the coating of a catalyst substrate according to claim 21, wherein the coating suspension contains a polymeric pore-forming agent which comprises a polymer or copolymer selected from the group consisting of polyethylene, polypropylene, polyurethanes, polyacrylnitriles, polyacrylate, polymethacrylate, polyvinylacetate, polystyrene and mixtures thereof.

23. Process for the coating of a catalyst substrate according to claim 21 wherein the polymeric pore-forming agent comprises an artificial resin.

24. Process for the coating of a catalyst substrate according to claim 21, wherein the polymeric pore-forming agent is composed of agglomerated polymeric primary particles.

25. Process for the coating of a catalyst substrate according to claim 21, wherein the primary particles have an arithmetic mean diameter of from 0.5 μm to 2 μm.

26. Process for the coating of a catalyst substrate according to claim 21, wherein the agglomerated polymeric primary particles have an arithmetic mean diameter of from 10 μm to 100 μm.

27. Process for the coating of a catalyst substrate according to claim 21, wherein the polymeric pore-forming agent is disagglomerated by an ultrasound treatment.

28. Process for the coating of a catalyst substrate according to claim 21, wherein, relative to the solids content of the coating suspension, the polymeric pore-forming agent is contained in the coating suspension in a quantity of from 0.5 to 8 wt.-%.

29. Process for the coating of a catalyst substrate according to claim 21, wherein the calcination in step c) takes place at a temperature between of from 450° C. and 600° C.

30. Catalyst comprising a catalyst substrate with coating, wherein the catalyst is obtained by a process according to claim 21.

31. Catalyst according to claim 30, wherein the coating of the catalyst substrate has pores with a pore diameter of from 0.5 μm to 2 μm.

32. A diesel particle filter, diesel oxidation catalyst, NOₓ trap catalyst or selective catalytic reduction catalyst comprising the catalyst according to claim 30.
